(19) United States
(12) Patent Application Publication
(10) Pub. No.: US 2010/0207570 A1
(43) Pub. Date: Aug. 19, 2010

(54) Rapid charge transportation battery

(76) Inventor: Edward Milton McWhorter, Citrus Heights, CA (US)

Correspondence Address: Edward M. McWhorter, 6931 Greenbrook Circle, Citrus Heights, CA, 95621, US

(21) Appl. No.: 12/378,425

(22) Filed: Feb. 17, 2009

(51) Int. Cl. H02J 7/00

(52) U.S. Cl. 320/101

(57) ABSTRACT

The invention is method of rapid electrical charging of secondary cells without excessive heat generation. An ionic capacitor having a metal shell is placed in electrical contact with the metal positive nickel oxide plate of an Edison alkaline cell battery comprising a plurality of said cell plates. A heavily charged electrolyte flowing from the cathode system passes through the said ionic capacitor and conducts electrons through its metal shell into the positive metal plates of the battery thereby converting by chemical reduction the oxidized nickel oxide (NiO₃) to NiO. The expended charging electrolyte, which contains calcium hydroxide Ca(OH)₂ is a value-added product and is used in commercial production of acetylene and cyanimide. The flow volume weight of the electrolyte and its specific heat flowing through the said ionic capacitor and passing out of thermal contact with the battery electrolyte (KOH) carries away excessive heat from the battery. A plurality of such batteries when used in a transportation vehicle are placed in parallel circuit connection with the vehicle motor load such that they can be individually taken off-line for separate charging by a controller circuit while the vehicle is in use.

### CROSS REFERENCES

Ref. 1 U.S. Pat. No. 6,653,007 Alkaline Fuel Cell
Ref. 2 U.S. Pat. No. 6,831,825 Ionic Capacitor
Ref. 3 U.S. Pat. No. 7,288,335 Alkaline Fuel Tape

### BACKGROUND OF THE INVENTION

Electrical charging of secondary cells occur when a reverse current is forced through the combined cells of the battery. The storage capacity of the battery is specified as the product of the electrical charge retained in the battery electrodes for an operating duration specified in hours, such that the said capacity of the battery is given in amp-hours. During the charging period all of the chemical oxidation reactions that occur during discharge are reversed restoring the cell electrode elements of the battery to their original reduced state. The paired electrode system presented is a nickel-cadmium combination emersed in an alkaline electrolyte.

(NiO₃|KOH|Cd)

The electrode chemical reactions that take place during charging and subsequent discharging during vehicle operation are those respectively presented below as Eq. 1 and Eq. 2.

$$\begin{matrix}2 {NiO}^{+} + 2 KOH + \overline{CdO} {->}^{charging} {{Ni}_{2} {O}_{3}}^{+} + 2 KOH + \overline{Cd} & Eq . 1 \\ {{Ni}_{2} {O}_{3}}^{+} + 2 KOH + \overline{Cd} {->}^{discharging} 2 {NiO}^{+} + 2 KOH + \overline{CdO} & Eq . 2\end{matrix}$$

The average discharge voltage of each electrode pair is about 1.2 volts. The nominal voltage of the battery is the product of the number of cells and the average cell voltage. The total voltage when used in a vehicle is called the system specific power. The value of the specific power relates to vehicle speed, acceleration, weight as expressed in terms of watts per vehicle weight (watts/lb).

The vehicle battery circuit is comprised of a plurality of batteries. Sets of batteries in the said battery system will be alternated into service while other sets are undergoing recharging operation. Alternating charging and discharging operations will be electronically controlled. There are a number of controlling methods that can be used to alternate given individual battery circuits between the charging and discharging mode but these are optional discretionary considerations and do not substantially effect the novelty of the invention which is to charge the battery circuit by electron discharge from an ionic capacitor described in Ref 2. The charging equipment is an electrolytic fuel cell (EFC) described in Cross-Reference Ref 1 and the alkaline fuel supply to the fuel cell is by a charging tape described in Cross Ref. 3. The fuel cell charges the vehicle batteries through a direct current (dc) ionic capacitor as described in the said Ref. 2.

The nickel-cadmium transportation battery has an indefinite shelf-life stored within the vehicle whether in the charged or discharged condition. The electrolyte is potassium hydroxide (KOH) and does not undergo chemical change during charging, discharging or in storage, its singular function is to act as a class-2 electrical conductor in the alternating direction of migration of the electrons during the charging and discharging periods resulting in the opposing alternate oxidation and reduction reactions of chemical elements of each respective positive and negative electrode.

The principle advantages of the Nickel-Cadmium alkaline battery are:
Weight advantage in specific power
Rapid charging capability (faster availability of specific energy)
Low maintenance since the electrolyte does not chemically change or react with electrode elements during the lifetime of the battery.

Individual cells of the transportation battery are charged by connecting them to a voltage source that is greater than the battery discharged voltage. In the present invention the said voltage source is a fuel cell. During the charging cycle the battery cells become the load rather than the energy source and therefore consequently its temperature is gradually increased and this temperature is accumulated. The faster the charging rate the faster the accumulated heat buildup. Too fast a charge rate will overheat the battery. Too slow a charging rate, as in the case of a trickle charge, impairs the specific energy required for practical highway propulsion speeds and acceleration. In order to alleviate this disadvantage the present invention employs an ionic capacitor Ref. 2 to charge the battery using the ionic charged cathode electrolyte as the charging current of a fuel cell described in Ref. 1.

Secondary cell storage batteries have reached an ultimate design level of capacity. Additional increase in specific energy in plug-in systems which allow a fully electric driving range in excess of 30 miles will require larger battery electrical storage capability or a method of rapid recharging existing size battery circuits while the vehicle is moving. The present invention is a method of recharging the vehicle battery circuits while the vehicle is in motion. The proposed system substantially increases the total electric propulsion specific energy necessary to increase the vehicle range.

To practically increase the specific energy of the vehicle battery bank, each battery circuit is placed in parallel electrical circuit with an electrolytic fuel cell which is powered by a calcium-sodium reduced metal fuel hydrolyzed in cathode compartment of the said fuel cell. In accordance with the First Law of Thermodynamics, hydrolysis and electrolysis are completely reversible. The electron energy released in the fuel cell cathodic chamber during hydrolysis is equivalent to the electrical energy expended in reduction of the metals during electrolysis. The volumetric capacity in cubic inches for one storage unit (28.5 in³) provides a charging capability of 958 amp-hrs for 5/95 mixture of sodium/calcium metal. With a 5 hour driving range the charging capacity must be 958 or 191 amps per hour. This very rough estimation assumes 100% efficiency without any allowance for other types of static charge losses. A much lower charging rate of about 50 amps is a practical figure in order to manage the thermal heat input (Q₁) which increases exponentially as the square of the current flow (I²) and linearly with the electrical resistance (R). The heat input is somewhat alleviated by the loss of heat (Q₂) of charging electrolyte passing out of the battery by the flow volume weight (wt) and its specific heat (cp) and the change of inlet and exit temperatures (Δt) and thereby permit's a faster charging rate.

### SUMMARY OF THE INVENTION

The invention is a method of charging alkaline secondary cell storage batteries using an ionic capacitor to transfer an electric current flow from a fuel cell.

It is an object of the invention to increase the specific energy of transportation batteries by rapid electrical charging while the vehicle is in motion and thereby increase the vehicle operating range.

It is another object of the invention to provide a method of storing the specific energy of transportation batteries on an electrical conductor tape which is activated by hydrolysis in a fuel cell cathode chamber and subsequently used to recharge the said transportation batteries.

It is yet another object of the invention to increase the charging rate of transportation batteries while simultaneously reducing the heating rate and accumulated heat during the charging period.

### BRIEF DESCRIPTION OF THE DRAWINGS

Drawings of the invention are presented.

FIG. 1 shows two positive nickel electrode tubes of an Edison cell.

FIG. 2 is a frontal view of the positive electrode plate which is designed to hold a plurality of positive nickel electrode tubes shown in FIG. 1.

FIG. 3 is a side view of the assembly of the positive electrode plates of FIG. 2 as mounted on an ionic capacitor that comprises the positive pole.

FIG. 4 is a cutaway of the lower portion of the nickel electrode assembly of FIG. 3 mounted on the ionic capacitor which is shown in longitudinal section.

FIG. 5 is the negative cadmium cellular plate of the transportation battery.

FIG. 6 is a side view of the electrode assembly of the negative pole of the transportation battery.

FIG. 7 is a perspective drawing of the assembled transportation battery shown in partial sectional views.

### DETAILED DESCRIPTION OF THE INVENTION

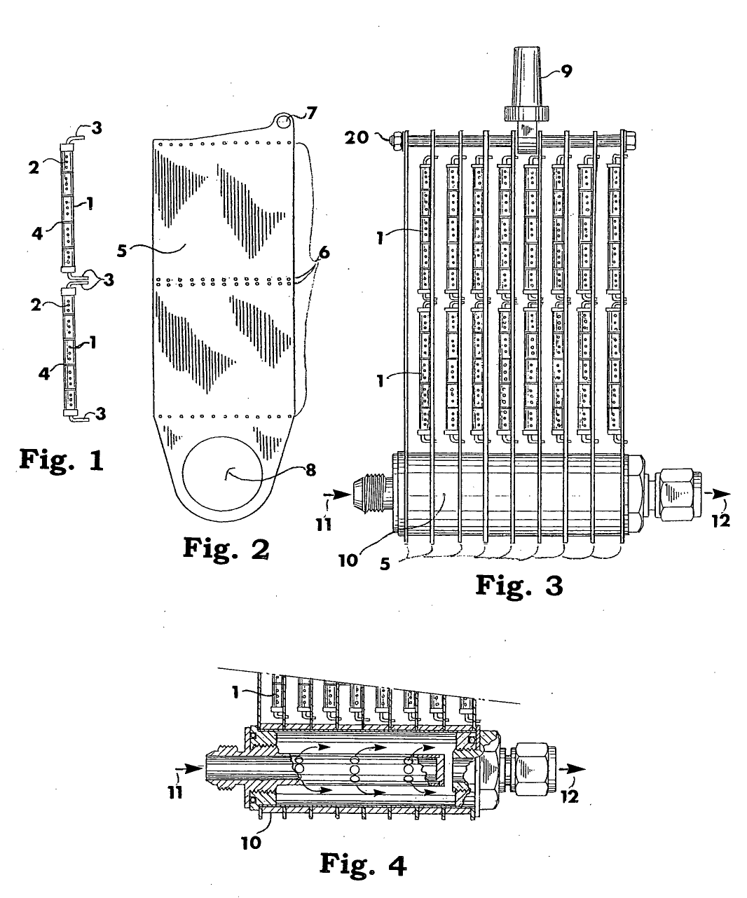

FIG. 1 is a drawing of two positive pole nickel electrode tubes 1. The tubes 1 are constructed from a thin cold rolled carbon steel ribbon having numerous small holes 2. At each end of tubes 1 are wire conductors 3 for electrical contact and mounting on the battery positive pole support plate 5 structure. Dispersed within tube 1 are numerous alternating layers of Nickel oxide (NiO) and porous nickel flakes (Ni). The active material is the said (NiO) and the said porous (Ni) is used only to improve electrode internal conductivity thereby shorten the required time for charging. Five steel rings 4 are periodically evenly spaced within tube 1 for additional reinforcement.

FIG. 2 is a positive support plate 5 having four horizontal rows of electrode holes 6, an assembly hole 7, and a large capacitor hole 8 for mounting plate 5 on an ion capacitor.

FIG. 3 is a side view of the positive pole 9 assembly of the battery comprising those numbered elements of FIG. 1 and FIG. 2 mounted on ion capacitor 10. Charging fuel cell cathode electrolyte enters ion capacitor inlet 11 passing through ion capacitor and out of capacitor through outlet 12. The holes 2 of the upper end of assembly plate 5 are used for assembly and uniform spacing on threaded rod 20.

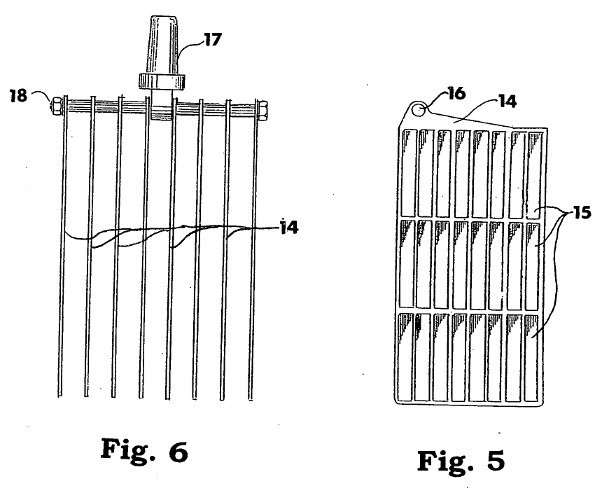

FIG. 4 is a partial view of the lower portion of FIG. 3 showing the ion capacitor 10 in section to illustrate the flow path of the fuel cell cathode electrolyte within ion capacitor 10.

There are several electrolytic fuel cell (EFC) cathode electrolytes which can function equally well as charge transfer class 2 conductors for charging the positive nickel pole. In the present system the selected charging electrolyte is a mixture of calcium hydroxide (CaOH₂) and sodium hydroxide (NaOH). These expended electrolytes after passage through the ion capacitor are collected as value added substances and electrolytically reacted in a capacitor tuyere with flue gas CO₂ to synthesize calcium cyanamide and acetylene.

FIG. 5 is the battery negative pole steel support plate 14 having a plurality of long rectangular indentures 15 to hold the cadmium (Cd) negative electrode ingredient. The advantages of Cd in place of iron (Fe) as in the case of the Edison cell is that it requires a lower charging potential and it does not become passive at high rates of discharge at low temperatures. Another advantage of cadmium is that it is not susceptible to self discharge as is the case of iron electrodes in the Edison cell. At the top of negative pole support plate 14 is hole 16 for assemblage of the battery support plates 14 on each side of the negative pole 17 and held in place by threaded steel rod 18.

FIG. 6 is a side view of the battery negative pole 17 assembly of the cadmium support plates 14 on steel rod 18.

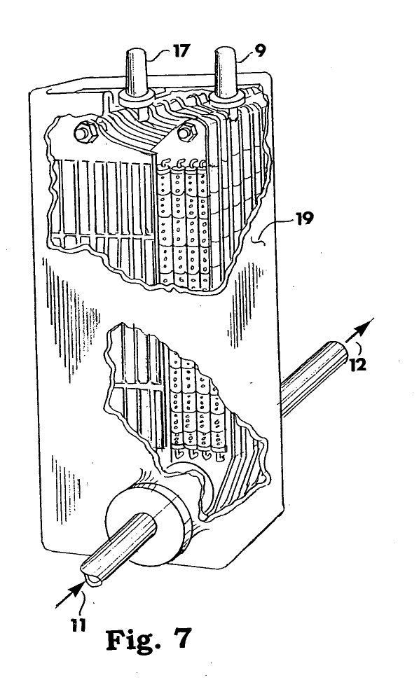

FIG. 7 is a drawing of the positive and negative pole battery cells mounted in steel battery case 19 also holding ion capacitor 10.

### NUMBERED ELEMENTS

1. Electrode tubes
2. Holes
3. Wire conductors
4. Steel rings
5. Assembly support plate
6. Holes
7. Assembly hole
8. Capacitor hole
9. Positive pole
10. Ion capacitor
11. Capacitor inlet
12. Capacitor outlet
13. Indents
14. Negative pole support plate
15. Indentations
16. Assembly hole
17. Negative pole
18. Steel rod
19. Battery case
20. Assembly rod

What is claimed is:

1. A method of electrically charging an electrically discharged alkaline secondary cell storage battery using an ionic capacitor class 2 conductor current comprising the charged ionic cathode electrolyte from an electrolytic fuel cell, said ionic capacitor outer class 1 metal conducting surfaces being in electrical contact with the steel support plates of the positive nickel pole of a nickel-cadmium secondary cell of said storage battery recharging the said electrically discharged storage battery.
